(19) United States
(12) Patent Application Publication
(10) Pub. No.: US 2005/0112920 A1
(43) Pub. Date: May 26, 2005

(54) Cable assembly and method of making

(76) Inventors: John T. Venaleck, Painesville, OH (US); Larry M. Crofoot, Perry, OH (US); Kenneth W. Braund, Concord, OH (US)

Correspondence Address: Jonathan A. Platt;Renner, Otto, Boisselle & Sklar, LLP, Nineteenth Floor, 1621 Euclid Avenue, Cleveland, OH, 44115, US

(21) Appl. No.: 10/993,075

(22) Filed: Nov. 19, 2004

Related U.S. Application Data
(60) Provisional application No. 60/523,976, filed on Nov. 21, 2003.
(60) Provisional application No. 60/599,740, filed on Aug. 6, 2004.

(51) Int. Cl. H01R 4/66

(52) U.S. Cl. 439/92

(57) ABSTRACT

A male connector, which may be configured to mate with standard interfaces such as 4X or 12X interfaces, includes multiple modules stacked together. The modules each include a shield, signal contacts, and may include an equalization device. The equalization device may be directly connected to the signal contacts, overlapped by the shields of the module and an adjacent module. The equalization device may be a passive device, for example being a resistor and a capacitor in parallel. A nosepiece may be coupled to an insertion end of the connector to maintain desired spacing of the signal contacts and shields. The connector may include an accessibility tab to release latches. The male connector may be part of a cable assembly, with a cable that has a strain relief that includes a ridged collar and a shrink tube.

This application claims priority under 35 USC 119(e) from U.S. Provisional Application No. 60/523,976, filed Nov. 21, 2003, and from U.S. Provisional Application No. 60/599,740, filed Aug. 6, 2004. Both of these provisional applications are hereby incorporated by reference in their entireties.

### TECHNICAL FIELD

The invention is in the general field of electrical connectors.

### SUMMARY OF THE INVENTION

According to one aspect of the invention, a cable assembly includes multiple modules that are each coupled to a transmission line of the cable, wherein the coupling between the transmission lines is within shields of the modules.

According to another aspect of the invention, a cable assembly includes multiple modules stacked together, wherein each module has a pair of signal contacts and a shield, with shields located between the signal contacts of adjacent modules. Signal wires may be coupled to the signal contacts in a side-by-side configuration, with the signal wires coupled to the signal contacts of a module substantially within the plane of the contacts of the module.

According to yet another aspect of the invention, a cable assembly has modules that are stacked together in a direction perpendicular to a plane of a connector of the cable assembly.

According to still another aspect of the invention, a cable assembly includes a transition region in which signal wires are coupled to signal contacts, wherein the contacts and the wires are substantially co-planar in the transition region.

According to a further aspect of the invention, a cable assembly includes a transition region in which signal wires are coupled to signal contacts, wherein the transition region has a length of less than about 0.20 inches, and preferably less than about 0.15 inches.

According to a still further aspect of the invention, a cable assembly includes a transition region in which signal wires are coupled to signal contacts, wherein the transition region is electrically shielded between conductive shields of modules of the cable assembly.

According to another aspect of the invention, a cable assembly includes multiple modules that are inserted into a connector body, wherein each of the modules includes at least one signal contact on each side (major face) of an interface of the connector body.

According to still another aspect of the invention, a cable assembly includes a grip portion that can be pulled to disengage latches of the cable assembly, and to move the cable assembly away from engagement with a mating connector.

According to yet another aspect of the invention, a cable assembly includes an accessibility tab that can be flipped up to disengage latches coupling a male connector of the assembly to a corresponding female connector. After disengaging the latches, the accessibility tab can be pulled to move the cable assembly away from the female connector.

According to a further aspect of the invention, a male connector for mating with standard I-O interfaces, such as 4X or 12X interfaces, includes multiple modules, each including a pair of signal contacts, that are stacked together and fixed in position.

According to a still further aspect of the invention, a male connector includes multiple modules that are stacked together, and that are coupled to a nosepiece that maintains desired positions of signal contacts of the modules.

According to another aspect of the invention, a connector may include equalization devices directly connected to signal contacts, wherein the equalization devices are each between and overlapped by a pair of adjacent shields.

According to yet another aspect of the invention, a connector includes multiple modules, each of which includes a conductive shield, and a ground bus mechanically and electrically coupled to each of the shields.

According to still another aspect of the invention, a strain relief for a cable end includes a collar having a ridge, and shrink tube. The collar is placed over the cable end, metal braid of the cable is folded over the ridge, and the shrink tube is used to seal the free ends of the metal braid.

According to another aspect of the invention, a cable assembly includes a male connector that includes: multiple modules stacked together and staked together, wherein each of the modules includes a pair of signal contacts substantially parallel to a planar shield of the module; and a nosepiece that is coupled to the modules, wherein the nosepiece includes slots for receiving portions of the signal contacts and the shields of each of the modules, to maintain a desired separation between the signal contacts and the shields; and a cable having signal wires that are coupled to the signal contacts of the modules.

According to yet another aspect of the invention, a male electrical connector includes multiple modules stacked together. The modules are heat staked together. The connector is configured to mate with a 4X/12X connector.

According to still another aspect of the invention, an electrical connector includes: a pair of signal contacts between planar shields; and an equalization device directly coupled to the signal contacts. The equalization device is between the shields and is overlapped by the shields.

According to a further aspect of the invention, a cable assembly includes: a cable that includes a transmission line having signal wires; and a connector having signal contacts that are electrically connected to the signal wires. Impedance of the signal wires in a transition line region within the cable is substantially the same as impedance of the signal contacts in a contact region within the connector, and is substantially the same as impedance of the signal wires in a transition region within the connector.

According to a still further aspect of the invention, an electrical connector includes: signal contacts; an angled back shell at least partially enclosing the signal contacts, wherein the angled back shell has an opening at one end angled relative to a direction at which the signal contacts are directed at an opposite end; and a latching mechanism. The latching mechanism includes latches for coupling the connector to a mating connector; a grip portion mechanically coupled to the latches, and translatable relative to the angled back shell, wherein the grip portion may be translated relative to the angled back shell to release the latches; and an accessibility tab mechanically coupled to the grip portion, wherein rotation of the accessibility tab translates the grip portion relative to the angled back shell.

According to another aspect of the invention, an electrical connector includes: a plurality of modules stacked together, wherein each of the modules includes a conductive shield, and wherein the conductive shields are located between pairs of adjacent modules; and a ground bus mechanically and electrically coupled to each of the conductive shields.

According to yet another aspect of the invention, a cable assembly includes: a cable having a dielectric casing and a metal braid within the dielectric casing; a collar over an end of the cable, wherein the collar includes an external ridge extending radially outward; and a shrink tube. The metal braid is folded outward over the ridge of the collar. The shrink tube is placed over and seals free ends of the metal braid.

It will be appreciated that the aspects described above are merely examples of the many aspects described herein, and that the cable assembly does not necessarily include all of the described aspects.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, which are not necessarily to scale:

FIG. 1 is a partially exploded view of a cable assembly in accordance with the present invention; 1

FIG. 2 is plan view of portions of a module that is part of the cable assembly of FIG. 1;

FIG. 3 is a side view of the portions of the module;

FIG. 4 is a cross-sectional view showing the configuration of signal wires and other components in a cable or transmission line region of the cable assembly of FIG. 1;

FIG. 5 is a cross-sectional view showing the configuration of components in a transition region of the cable assembly of FIG. 1, where the signal wires are coupled to signal contacts;

FIG. 6 is a cross-sectional view showing the configuration of components in a contact region of the cable assembly of FIG. 1;

FIG. 7 is an oblique top view illustrating a first step in the formation of a module for the cable assembly of FIG. 1;

FIG. 8 is an oblique bottom view illustrating a second step in the formation of a module for the cable assembly of FIG. 1;

FIGS. 9 and 10 are oblique top and bottom views, respectively, illustrating a third step in the formation of a module for the cable assembly of FIG. 1;

FIGS. 11 and 12 illustrate another step in the formation of the cable assembly of FIG. 1, stacking together several of the modules;

FIG. 13 illustrates yet another step in the formation of the cable assembly of FIG. 1, inserting the stacked modules into a connector body;

FIG. 14 is a plan view illustrating termination of transmission lines of a cable used for coupling to modules of the cable assembly;

FIG. 15A is a plan view illustrating a straight-line cable assembly with a back shell and latching mechanism;

FIG. 15B is an oblique view of a part of a straight-line cable assembly, showing a pull loop which may be used in releasing latches of the cable assembly;

FIG. 16 is a plan view of the cable assembly of FIG. 15A, with one part of the grip portion removed;

FIG. 17 is a plan view of the cable assembly of FIG. 15A, with one part of the grip portion and one part of the back shell removed;

FIG. 18 is an oblique view of the partially-disassembled portion of the cable assembly shown in FIG. 17;

FIG. 19 is detailed plan view of the latch mechanism shown in FIG. 16, showing details of the latching mechanism;

FIG. 20 is an oblique view of an angled cable assembly with a back shell and latching mechanism;

FIG. 21 is a side view of the cable assembly of FIG. 20;

FIG. 22 is a partially cutaway side view of the cable assembly of FIG. 20, with one part of the grip portion removed;

FIG. 23 is another partially cutaway side view of the cable assembly of FIG. 20, illustrating alternate operation for disengaging latches, especially useful in confined spaces, involving use of an accessibility tab;

FIG. 24 is a partially cutaway plan view of an alternate embodiment cable assembly in accordance with the present invention; and

FIG. 25 is an exploded view of another embodiment of a male connector in accordance with the present invention;

FIG. 26 is an oblique view of a module of the male connector of FIG. 25;

FIG. 27 is a plan view of the module of FIG. 26;

FIG. 28 is a sectional view along section 28-28 of FIG. 27;

FIG. 29 is a sectional view along section 29-29 of FIG. 27;

FIG. 30 is a plan view showing details of signal contact tips of the module of FIG. 26;

FIG. 31 is a plan view of a shield of the module of FIG. 26;

FIG. 32 is detailed view of the shield clip portion of the shield of FIG. 31;

FIG. 33 is an oblique view of a first end module of the connector of FIG. 25;

FIG. 34 is an oblique view of a second end module of the connector of FIG. 25;

FIG. 35 is an oblique view of a nosepiece of the male connector of FIG. 25;

FIG. 36 is an oblique view of a portion of the nosepiece of FIG. 35, showing details of the slots of the nosepiece;

FIG. 37 is an end view of the nosepiece of FIG. 35;

FIG. 38 is a sectional view along section 38-38 of FIG. 37;

FIG. 39 is a sectional view along section 39-39 of FIG. 37;

FIG. 40 is an oblique view of another cable assembly in accordance with the present invention;

FIG. 41 is an oblique view of a module of the cable assembly of FIG. 40;

FIG. 42 is a cross-sectional view of the cable of the cable assembly of FIG. 40;

FIG. 43 is a partially cutaway view of a strain relief on the cable of the cable assembly of FIG. 40; and

FIG. 44 is cutaway view of the strain relief of FIG. 43 installed in a back shell of the cable assembly of FIG. 40.

### DETAILED DESCRIPTION

A cable assembly includes a connector having multiple modules, with each of the modules coupled to a transmission line of a cable. The modules each include a pair of signal contacts and a ground plane or shield, held together by a dielectric module body. Signal wires of the transmission line are conductively connected to signal contacts of the module, and a drain line is coupled to the shield or ground plane of the module. These couplings are made within a transition region shielded by the various shields of the modules. Impedance matching is provided within the transition region, providing substantially the same or a similar impedance between a transmission line region and a contact region. (In the transmission line region the signal wires are shielded by transmission line shielding. In the contact region the signal contacts are shielded by the shield or ground plane of the module. In the transition region between the transition line region and the contact region, both the signal wires and signal contacts are shielded by the shield or ground plane of the module.) The modules may be stacked together, with each of the modules having its signal contacts perpendicular to a general plane of the connector. The stacked modules may then be inserted into suitable slots in a body portion of the connector body. A connector interface of the body may have one contact for each of the modules on the one side of the interface and the other contact of each of the modules on an opposite side of the interface.

The back shell that encloses the connector may have a release mechanism that operates intuitively, for example, allowing release of latches holding the mating connector halves, when the back shell is gripped and pulled in a direction that releases the male cable connector from the mating female connector. The back shell may be provided with a loop pull to facilitate gripping and pulling. Alternatively or in addition, the back shell may be an angled shape, with an external accessibility tab that may be rotated and pulled to release latches coupling the male cable connector to a mating female connector. The angled shape provides for an angled cable exit path for use where space is restricted. The accessibility tab may be used to release the latches in situations where space is limited. Thus, the angled shape and the accessibility tab may enable closer spacing of the connector portions of cable assemblies.

In another embodiment, a male connector, which may be configured to mate with standard interfaces such as 4X or 12X interfaces, includes multiple modules stacked and staked together. The modules each include a shield and signal contacts, and may include an equalization device. The equalization device is directly connected to the signal contacts, overlapped by the shields of its module and an adjacent module. The equalization device may be a passive device, for example being a resistor and a capacitor in parallel. A nosepiece may be coupled to an insertion end of the connector to maintain desired spacing of the signal contacts and shields.

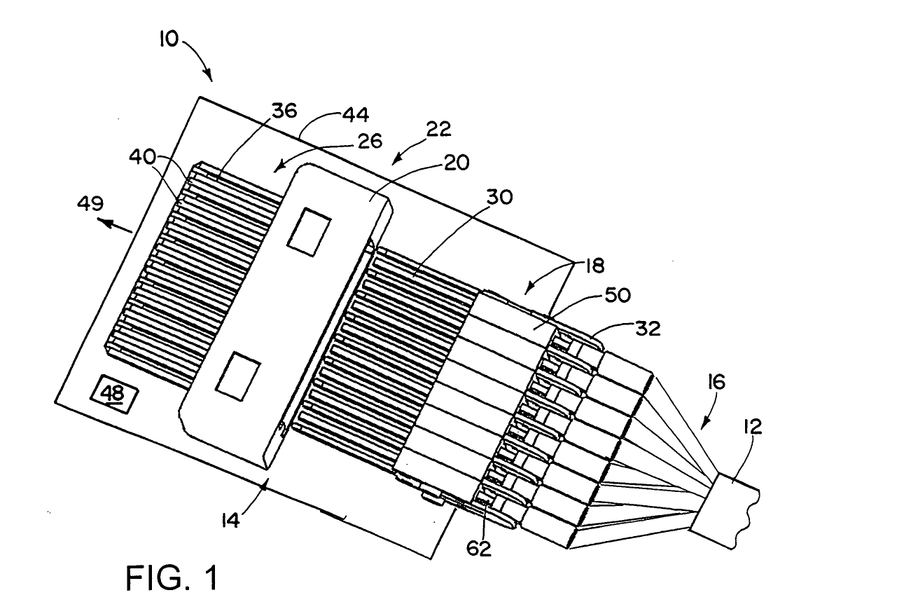

FIG. 1 shows a cable assembly 10 that includes a cable 12, and a male connector 14 coupled to the cable 12. Individual of the transmission lines 16 of the cable 12 are coupled to respective modules 18 that are stacked together and nested with one another. The stacked modules 18 are inserted into a body portion 20 of a connector body 22. The connector body 22 also includes a connector interface 26, which is inserted into and mates with a corresponding female connector. Each of the modules 18 includes a pair of signal contacts 30, and a conductive shield or ground plane 32. The shields 32 of the various modules 18 are inserted into slots in the body portion 20, and emerge from the body portion 20 into shield-receiving slots 36 in the connector interface 26. The signal contacts 30 of each of the modules 18 are inserted through the body portion 20 of the connector body 22, and emerge into and are located in contact-receiving slots 40 of the connector interface 26. Thus, corresponding sets of the contact-receiving slots 40 are on opposite major surfaces of the connector interface 26. That is, there is one set of the contact-receiving slots 40 on the face-up portion of the connector interface 26, as illustrated in FIG. 1, and a substantially-identical set of the contact-receiving slots on the face-down portion of the connector interface. Each of the modules 18 has one of its signal contacts 30 on one major surface of the connector interface 26, and the other of its signal contacts 30 on the opposite major surface of the connector interface 26.

The male connector 14 is enclosed by a suitable back shell. A back shell half 44 that forms part of this back shell is shown in FIG. 1. A corresponding back shell half may be mated with the back shell half 44, to form a suitable back shell enclosing at least part of the connector body 22, and the modules 18. The back shell may have suitable latches for coupling the cable assembly to a mating female connector. A suitable release mechanism may be used to release the latches.

The connector interface 26 defines a plane 48 of the connector. The signal-contacts 30 of the modules 18 are arrayed within or parallel to the connector plane 48. Further, the signal contacts 30 are inserted into the connector body 22 in a connection direction 49 of the connector 14. The connection direction 49 is the direction in which the male connector 14 is inserted into a corresponding female connector. The male connector 14 may have a configuration that is suitable for mating with a standard interface, such as interfaces used for joining together computer components or other electronic components. For example, the cable assembly 10 may have a configuration designed to mate with standard I-O interfaces such as the 4X and 12X interfaces. FIG. 1 shows a cable assembly configured to mate with a 4X interface. It will be appreciated that other suitable interfaces may be utilized to mate with other sorts of connectors.

Each of the modules 18 includes a module body 50. The dielectric module body 50 serves to maintain proper positioning by the other components of the module 18 relative to the shield 32.

The module body 50 may be made of any of a variety of well-known, moldable thermoplastic materials. The connector body 22 may be made of a similar thermoplastic material.

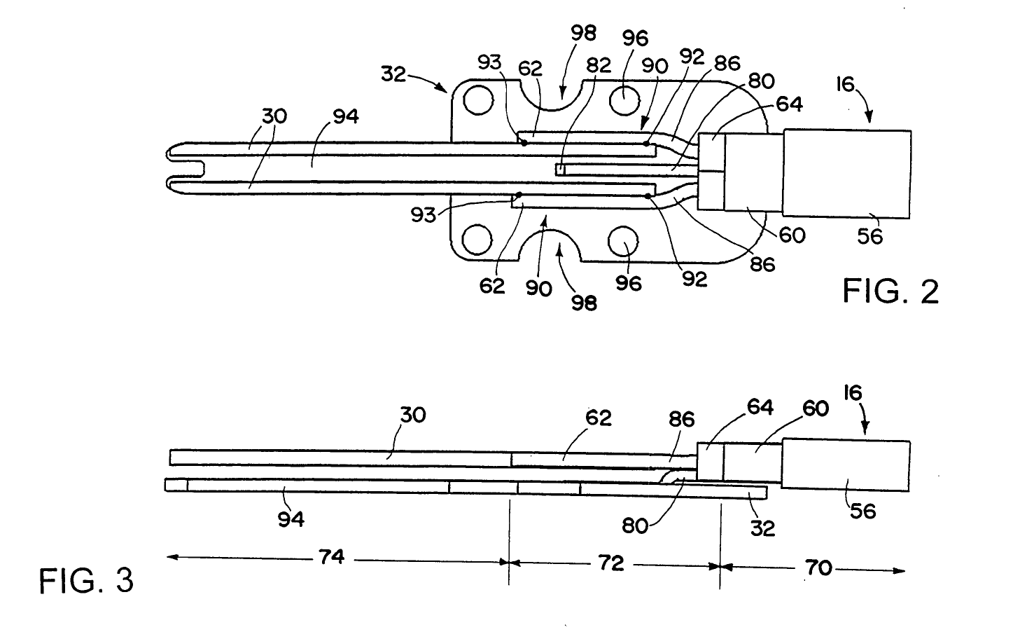

Turning now to FIGS. 2 and 3, details are shown and described for connection of one of the transmission lines 16 to one of the modules 18. For illustration purposes, the dielectric module body 50 is omitted in FIGS. 2 and 3.

The transmission line 16 includes a protective jacket 56 that covers and encloses a conductive layer of transmission line shielding 60. The shielding 60 provides electrical protection to a pair of signal wires 62, which are enclosed in respective dielectric layers 64. In addition, the shielding 60, which may be aluminum metallized MYLAR shielding, establishes the impedance of the transmission line 16.

The cable assembly 10 may be divided into three sections: a cable or transmission line region 70, a transition region 72, and a contact region 74. One objective in configuring the cable assembly 10 is to match impedance between the various regions 70-74, and to avoid disruption in the signals as they pass from the cable region 70 to the contact region 74. Thus, it will be desirable to match impedance in the three regions 70, 72, and 74. Discontinuities in impedance within the cable assembly 10 result in signal reflection, crosstalk, and/or other signal imperfections. It is also desirable to electrically isolate the signals of one of the modules 18, from signals of other of the modules, and from other outside sources of electrical interference. The cable assembly 10 accomplishes these goals in a variety of ways. The transition region 72 may be kept substantially fully within the protection of the shield or ground plane 32. For purposes of this application, the transition region 72 is defined as the region from where the transmission line shielding 60 is peeled back away from the dielectric material 64 around the signal wire 62, to the location where the signal wires 62 make electrical connections to the signal contact 30 of the module 18. Thus, while the jacket 56 may be stripped way from the transmission line 16 outside of the covering of the shield 32, preferably the transmission line shielding 60 is maintained over the dielectric material 64 where the transmission line 16 is overlapped by the shield 32. A drain wire 80 is coupled to the transmission line shielding 60, and is conductively connected to the shield 32. The drain wire 80 fits into a slot 82 in the conductive shield 32.

Further along the transmission line 16, further into the region overlapped by the shield 32, the dielectric material 64 is stripped from the signal wire 62. The signal wires 62 are formed outward at bends 86, and are placed along the signal contacts 30. As can be best seen in FIG. 3, the signal wires 62 may be in substantially the same plane as the signal contacts 30. The signal wires 62 may be placed outboard of the signal contacts 30, and conductively coupled to the signal contacts 30 by conductive connections 90. Alternatively, the signal wires 62 may be placed inboard of the signal contacts 30. The conductive connections 90 between the signal wires 62 and the sets of corresponding signal contacts 30 may be by any of a variety of suitable methods, such as welding or soldering, for example resistance welding or laser welding.

The conductive connections 90, for example, may be welds 92 and 93 at ends of the overlap between the signal wires 62 and the signal contacts 30. By providing welds at two places, at both ends of the overlapped section, better electrical performance may be obtained relative to welded connections at a single point. This may be because welded connections at a single point leave unconnected portions of the signal contacts 30 and/or the signal wires 62 that may undesirably reflect signals along their length. This may result in undesirable effects, such as electrical noise or other irregularities.

The drain wire 80 may also be welded or otherwise coupled to the shield 32, within the slot 82. Passing further from the ends of the signal wires 62, the signal contacts 30 continue on, still substantially overlapped by a protruding portion 94 of the shield 32.

The conductive shield 32 has holes 96 for receiving the module body 50 (FIG. 1). Aside from the body-receiving holes 96 and the slot 82 for receiving the drain wire 80, the shield 32 may be a single piece of material, such made from a copper alloy, without holes therein. More particularly, the area of the shield 32 that overlaps the signal wires 62 and the contacts 30, may be without holes or other openings. This continuous, uninterrupted shielding of the signal wires 62 and the signal contacts 30 may provide an additional measure of shielding, in comparison to designs that have holes or other openings in an overlapping conductive shield. This may result in a reduction of crosstalk.

The signal contacts 30 may also be made of a copper alloy. The signal contacts may be plated with a suitable conductive material, such as gold, to enhance their conductive connection with the signal wire 62. The signal contacts 30 may be substantially axially aligned with the signal wires 62 as the signal wires 62 come into the shield 32 from the transmission lines 16 (prior to the bend 86). Alternatively, the signal contacts 30 may be offset somewhat from the axis of the signal wires 62.

The shield 32 has cutouts 98 for receiving corresponding protrusions on the module body 50 of another of the modules 18, to allow the modules 18 to be stacked together.

Disruptions to signals caused by the transition region may be reduced by reducing the length (in the general direction of the signal contacts 30) of the transition region 72. The length of the transition region 72 may less than about 0.20 inches, may be less than about 0.15 inches, or may have other values.

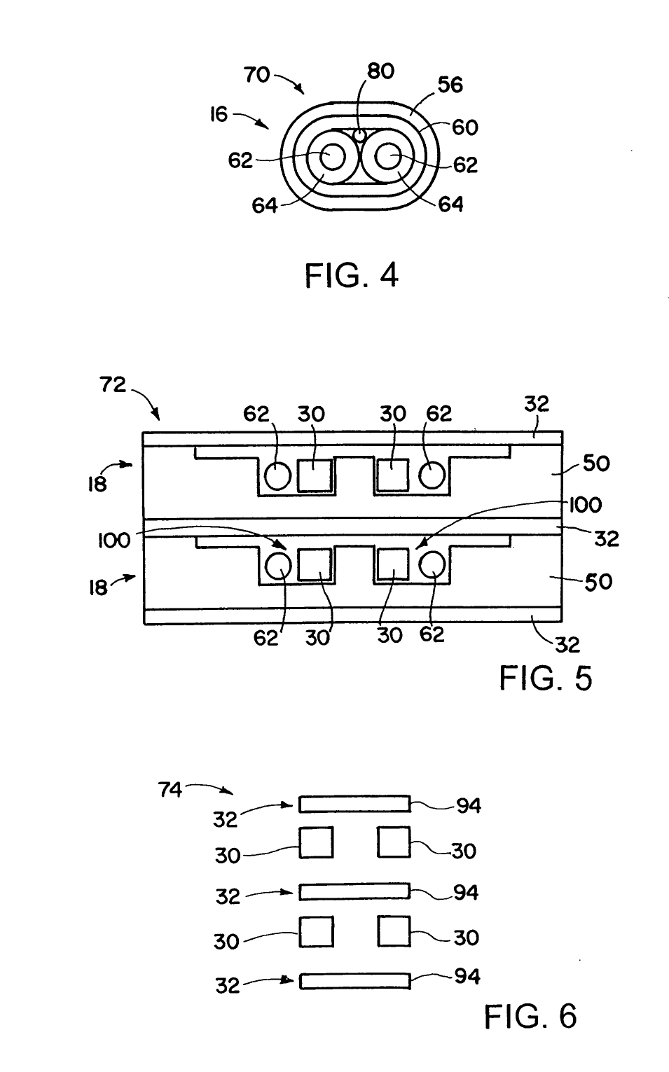

With reference now in addition to FIGS. 4-6, further discussion will now be given regarding the impedance matching mentioned above. FIG. 4 shows the cross section of a transmission line 16, before entry of the transmission lines 16 into the region surrounded by the conductive shield 32. This configuration, corresponding to the transmission line region 70, shows the transmission lines 16 in their state away from the connector 14, such as within the cable 12. The signal wires 62 are surrounded by a dielectric material 64, which keeps the signal wires 62 from making contact with the conductive shielding 60, as well as establishing the impedance of the transmission line 16. The conductive shielding 60 provides a shield to keep outside signals from adversely affecting the signals traveling through the signal wires 62, as well as establishing the impedance of the transmission line 16. The conductive shielding 60 may be a layer of metallized plastic material (MYLAR). The drain or ground wire 80 is in contact with conductive material of the conductive shielding. The jacket 56 provides protection for the shielding 60, for example, to maintain the integrity of the shielding 60, protecting for example, the shielding 60 from physical damage. The signal wires 62 may be maintained in a substantially constant electrical environment throughout the transmission line region 70, for example avoiding sharp bends or kinks in the transmission lines 16. Such sharp bends or kinks are undesirable in that they cause a discontinuity in the signal travel along the signal wires 62.

FIG. 5 illustrates the configuration in a portion of the transmission region 72 where the signal wires 62 are coupled to the signal contacts 30, with the signal wires 62 and the signal contacts 30 side by side within slots 100 in the dielectric module body 50. The slots 100 may be configured so that the signal contacts 30 and the signal wires 62 are midway between the shield 32 of the module 18, and the shield 32 of an adjacent module 18. In addition, the size and/or the shape of the slots 100 in the module body 50 may be configured so as to achieve a desired electrical environment in the transmission region 72. Specifically, the slots 100 may be configured so as to achieve impedance matching with the impedance encountered by the signal wires 62 in the transmission line region 70, and the impedance encountered by the signal contacts 30 in the contact region 74.

The contacts 30 and the signal wires 62 may have approximately the same height, taking up approximately the same distance between parallel shields 32 of adjacent of the modules 18. Alternatively, it will be appreciated that the height of the contacts 30 and the signal wires 62 may differ from one another. The slots 100 may be substantially rectangular slots. Alternatively, the slots 100 may have a different cross-sectional shape.

In one embodiment, the signal contacts 30 of adjacent of the modules 18 have center-to-center spacing of about 1.5 mm, although it will be appreciated that other spacings are possible.

FIG. 6 illustrates the environment in the contact region 74. It will be appreciated that the environment for the contacts 30 shown in FIG. 6 is not the final environment encountered by the signal contacts 30 and the fully installed cable assembly 10. Once the modules 18 are inserted into the connector body 22, the area between the signal contacts 30 and between the signal contacts and the shield protrusions 94, may be substantially filled by dielectric material of the connector body 22. The spacing between the signal contacts 30 may be dictated at least to some extent by the requirements that the male connector 14 (FIG. 1) mates with a corresponding standard female connector.

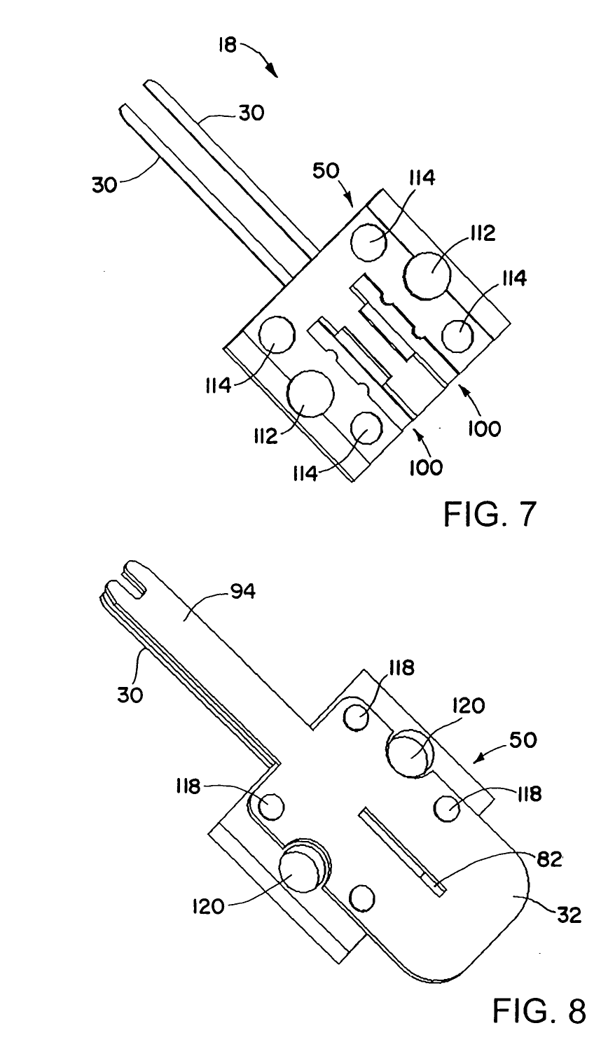

FIGS. 7-13 illustrate the assembly process for first one of the modules 18, and then for inserting a stack of the modules 18 into the connector body 22. As shown in FIG. 7, first the module body 50 is molded around a pair of the signal contacts 30. As noted above, the module body 50 has slots 100 that expose portions of the signal contacts 30, and allow the signal wires 62 to be placed next to the signal contacts 30 for the signal wires 62 to be conductively joined to the signal contacts 30. The module body 50 includes a pair of protrusions 112, configured to be mated with the cutouts 96 of the shield 32, allowing nesting and stacking of the modules 18 together. The module body 50 also has four recesses 114, which also aid in receiving and stacking together multiple of the modules 18.

Turning now to FIG. 8, the shield 32 is placed on a back face of the module body 50. Backside protrusions 118 on the module body 50 may be placed through the receiving holes 96 of the shield 32. The backside protrusions 118 may then be used to heat stake the shield 32 onto the backside of the module body 50. In FIG. 8 it may also be seen that the module body 50 has a pair of recesses 120 configured to receive the corresponding protrusions 112 of another module body 50. Part of the slot 82 in the shield 32 remains open, uncovered by the module body 50, to allow the drain wire 80 (FIGS. 2 and 3) to be passed therethrough for coupling to the shields 32 on the backside of the module 18.

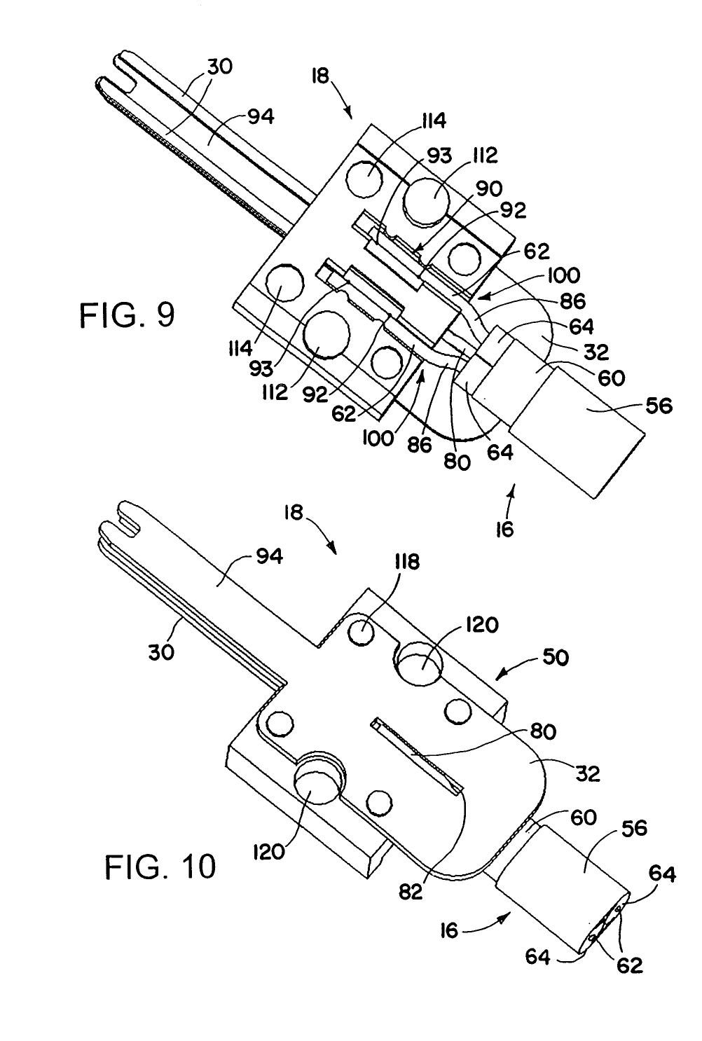

With reference now to FIGS. 9 and 10, the transmission line 16 is coupled to the module 18. The two signal wires 62 are welded or otherwise conductively coupled to the signal contacts 30, and the drain wire 80 is passed through the slot 82 and welded or otherwise coupled to the shield 32 along the back side of the module body 50. FIG. 10 shows a back view of the module 18, showing the coupling between the drain wire 80 and the shield 32.

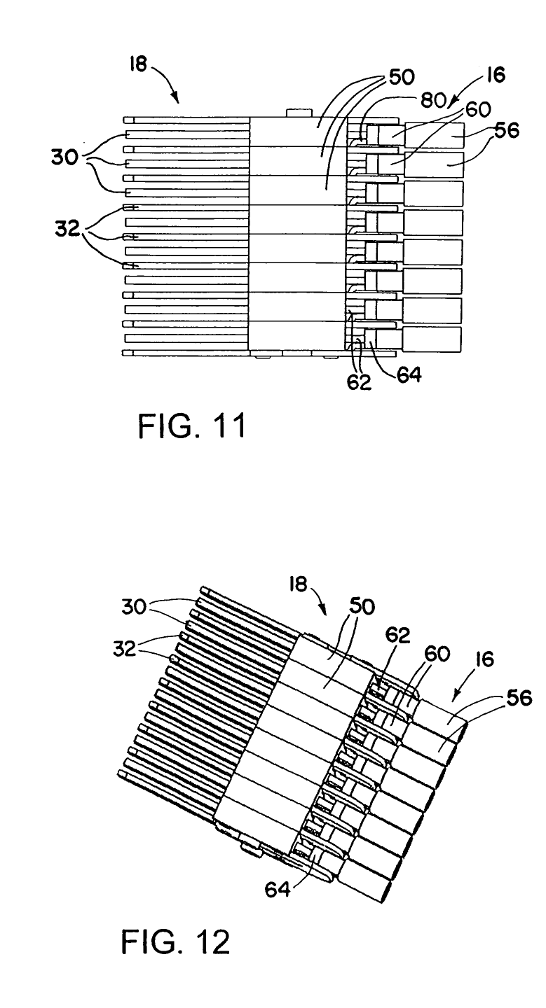

FIGS. 11 and 12 show the stacking of multiple of the modules 18 together. An additional shield 32 may be added to the stack, to provide shielding on both the top and the bottom of the stack of the modules 18.

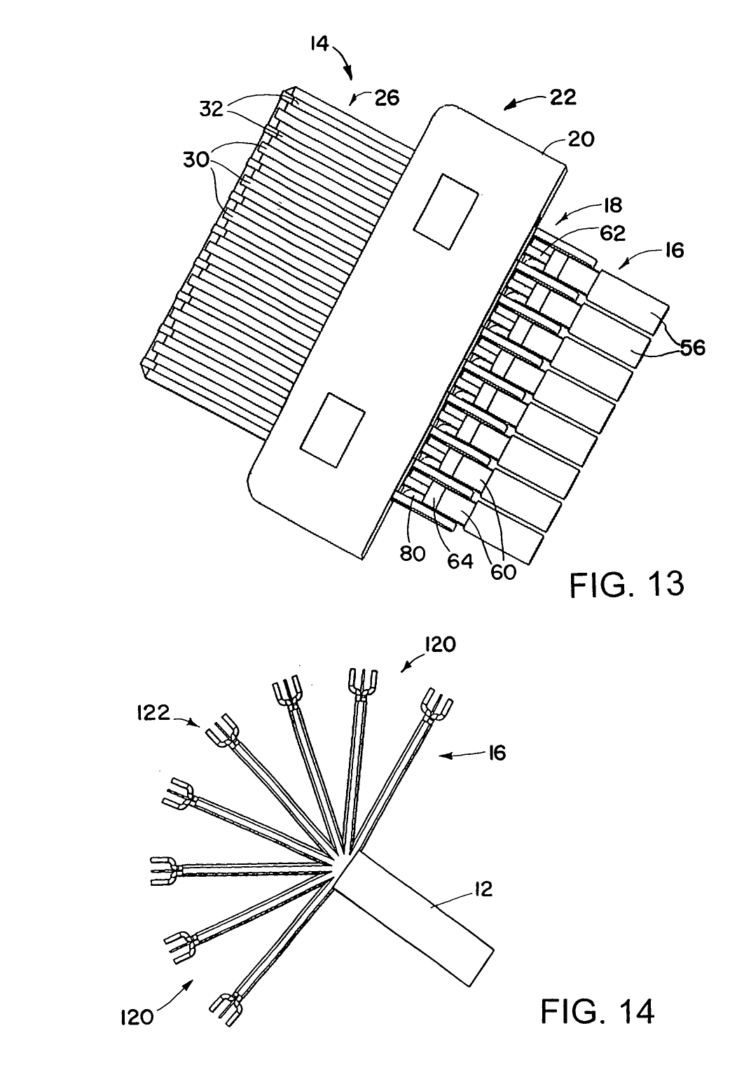

Following stacking the modules 18, the stack of the modules 18 is inserted into the connecter body 22, as illustrated in FIG. 13.

FIG. 14 illustrates spreading of the individual transmission lines 16 for connection to their respective modules 18 (FIG. 1). It will be appreciated that lengths of the unstripped portions of the various transmission lines 16 may be different from one another. For example, the transmission lines 16 on the ends, indicated by reference number 120 in FIG. 14, may be longer than the transmission lines 16 in the center, indicated by reference number 122 in FIG. 14. This is because more transmission line length is needed for the modules 18 at the end of the stack of modules. By varying the length of the portions of the transmission lines 16 extending beyond the cable 12, excess length of the transmission lines 16 may be avoided. This may aid in avoiding bending or kinking of the transmission lines 16 when the multiple modules 18 are stacked together. The transmission lines 16 may be maintained as shown in FIG. 14 in a suitable fixture, to their connection to the modules 18.

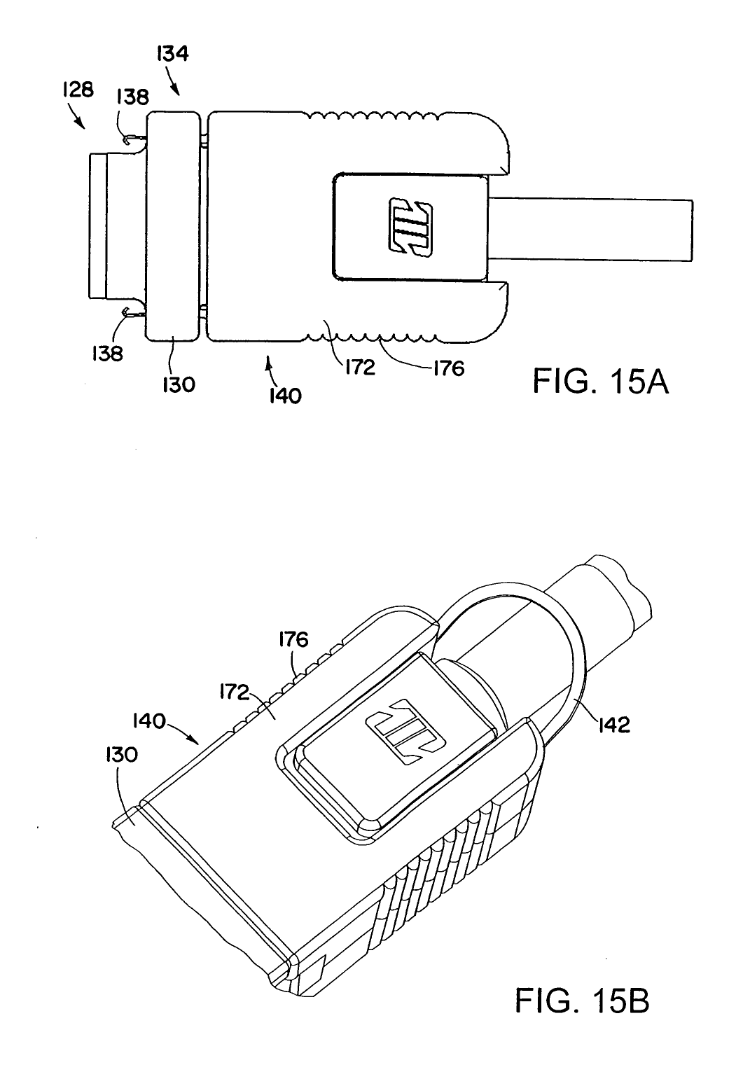

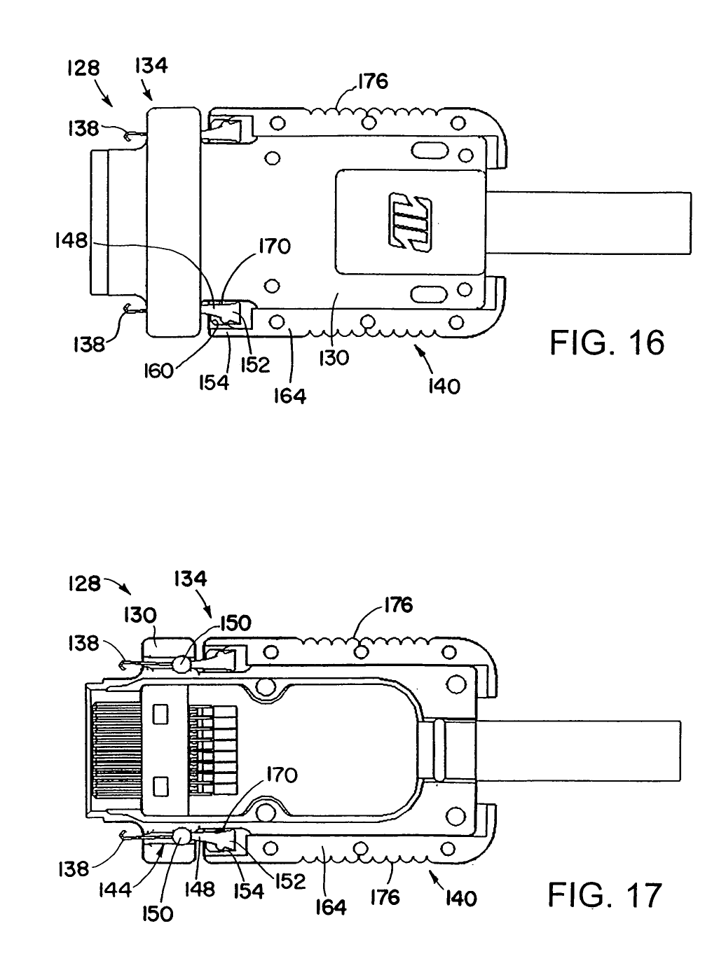

FIGS. 15A-18 illustrate a straight-connect cable assembly 128 that includes a back shell 130 and a translatable grip portion 140. The back shell 130 is a metal body that encloses the modules 18 (FIG. 1), and the translatable grip portion 140 is a plastic piece which is translatable relative to the back shell 130. The back shell 130 partially encloses a latch-release mechanism 134 for releasing a pair of latches 138. The translatable grip portion 140 is mechanically coupled to the latches 138 such that pulling the grip portion 140 causes the latches 138 to move outward and release. As shown in FIG. 15B, the latch release mechanism 134 may include a pull loop 142 that is attached to the grip portion 140, to aid in gripping and pulling on the grip portion 140 to release the latches 138.

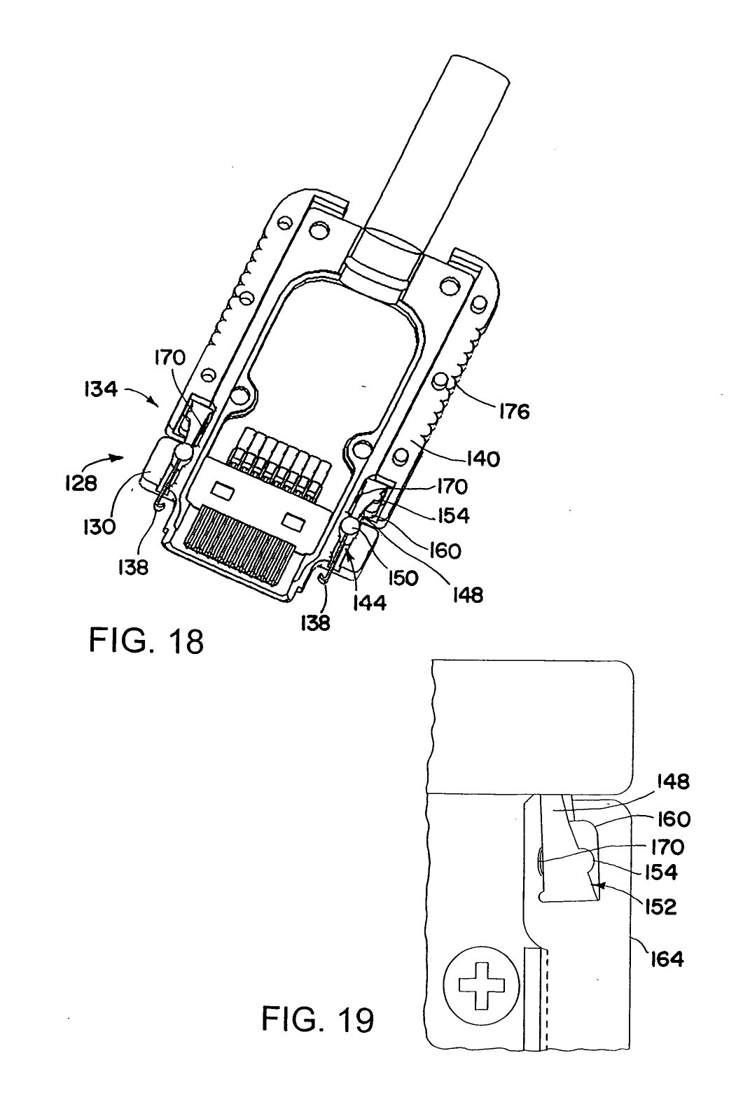

Referring now in particular to FIG. 18, details of interior workings of the latch release mechanism 134 are described. The latch 138 is attached to and emerges from a first end 144 of a rocker arm 148. The rocker arm 148 may be overmolded onto the metal latch 138. The rocker arm 148 rotates about an axis 150 to release the latch 138. On a second end 152 of the rocker arm 148, there are top and bottom cam surfaces 154, only one of which is shown in FIG. 19.

As the grip portion 140 is pulled back, in the direction of the cable 12, a sloped surface 160 of a bottom grip portion half 164 presses against the bottom cam surface 154, deflecting the second end 152 of the rocker arm 148 inward, against the force of a biasing spring 170. A similar sloped surface on the top grip portion half 172 (FIG. 15A; not shown in FIG. 19) presses against the top cam surface 154. As the second end 152 of the rocker arm 148 is pressed inward, the rocker arm 148 rotates about its axis 150, moving the first end 144 of the rocker arm 148 outward. This moves the latch 138 outward as well, releasing the latch 138, and allowing the cable assembly to be disengaged from a female connector mated to a male connector of the cable assembly.

The biasing spring 170 is between the back shell 130 and an inner surface of the second end 152 of the rocker arm 148. The biasing spring 170 fits into a recess in the inner surface of the second end 152, and serves to always press the second end 152 of the rocker 148 outward. When the grip portion 140 is released, the grip portion 140 translates back along the back shell 130, allowing the latch 138 to engage, driven by the biasing spring 170.

The latch release mechanism 134 provides an intuitive mechanism for disengaging the cable assembly from a female connector. The same pulling action that disengages the latches 138 is also used for pulling the cable assembly 10 away from the female connector. There is no need to hook onto a handle or other pulling mechanism, either with a finger or a hook. However, as noted above, a pull loop 142 may be provided as an alternate mechanism for disengaging the latches 132.

It will be appreciated that the latch release mechanism 134 provides a large mechanical advantage, which allows release of the latches 138 with a small force. The amount of mechanical advantage may be varied by varying suitable dimensions of the latch release mechanism 134, for example by varying the slope of the sloped surfaces of the back shell portions.

The back shell 130 may be made of a suitable metal, such as aluminum or steel. The grip portion 140 may be made of a suitable plastic material. The grip portion 140 may have a ridged gripping surface 176, to aid in gripping and pulling on the grip portion 140.

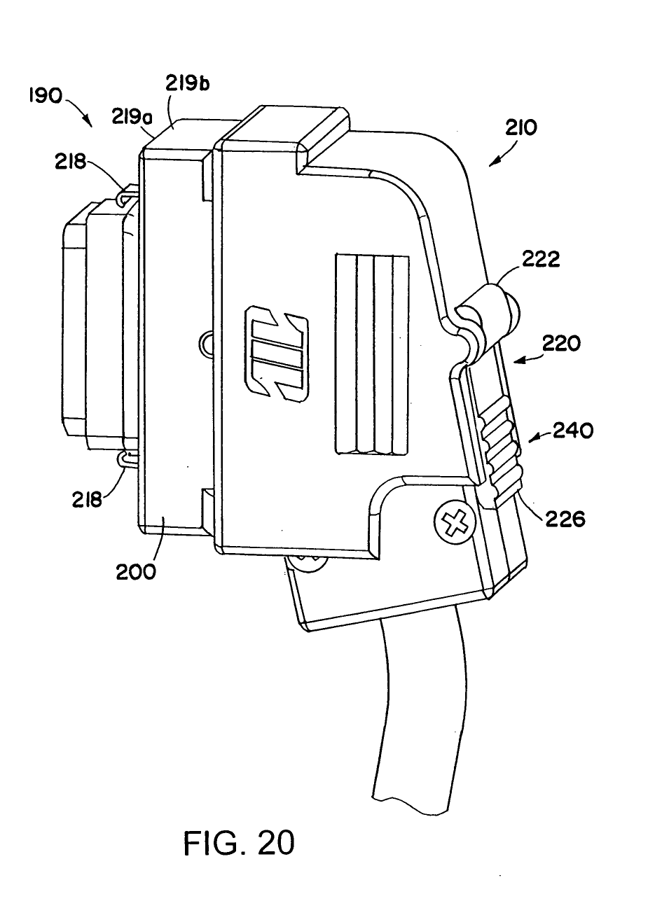

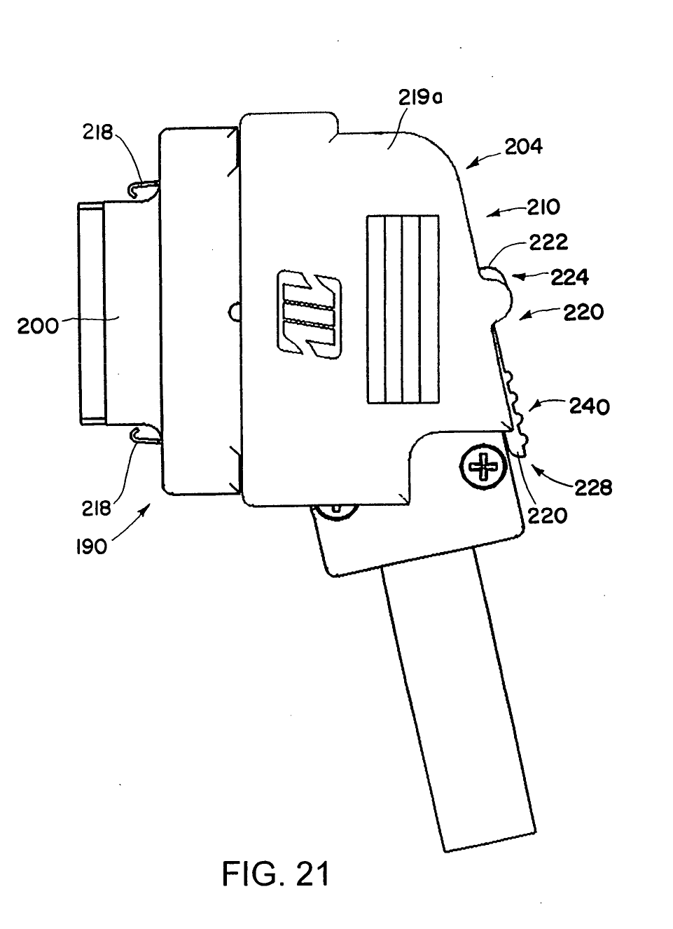

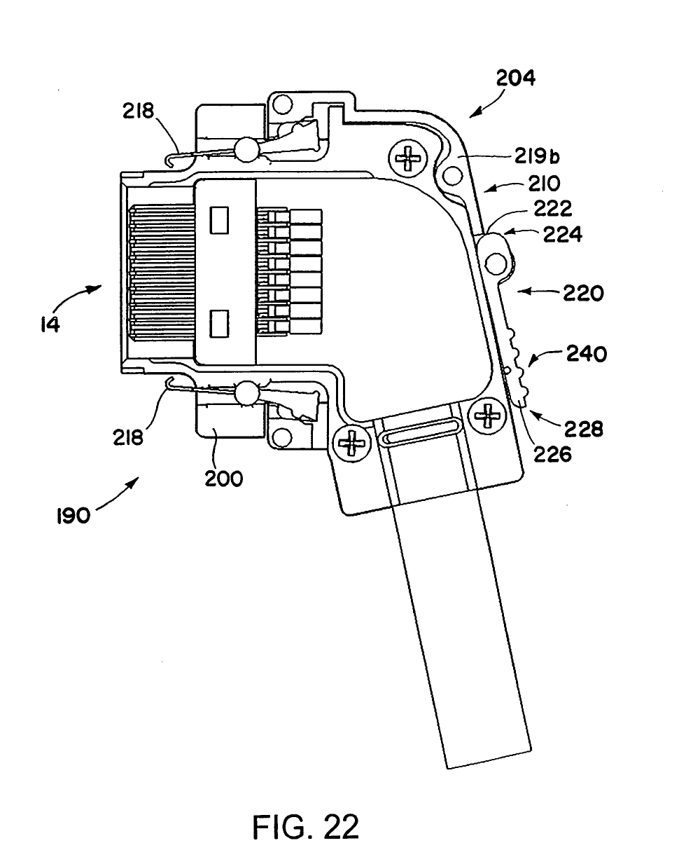

FIGS. 20-23 illustrate an angled cable assembly 190 that includes an angled back shell 200. The back shell 200 at least partially encloses a latch release mechanism 204 that in turn includes a translatable grip portion 210. The translatable grip portion 210 is translatable relative to the back shell 200 that is connected to and houses the connector 14 (FIG. 1). The translatable grip portion 210 may be moved back, away from latches 218, to move the latches 218 outward and disengage the latches 218 from a corresponding female connector. The mechanism that disengages the latches 218 when the grip portion 210 is moved backward may be similar to the mechanism described above with regard to the back shell 130.

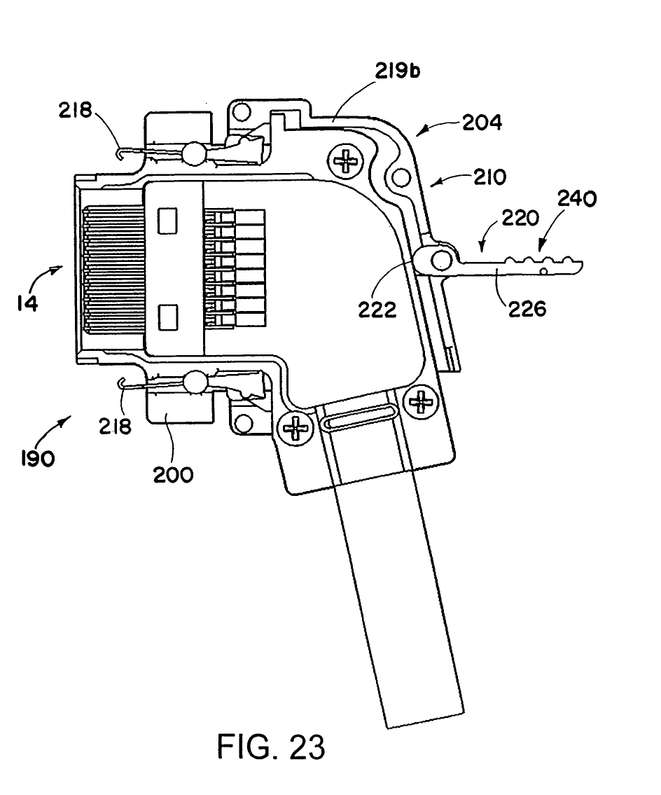

In addition to grasping the grip portion 210 and pulling it backward, the grip portion 210 may be translated backward by using an accessibility tab 220 that is mechanically coupled to the grip portion 210. The accessibility tab 220 is rotatably coupled to the grip portion 210, between a pair of halves 219a and 219b of the grip portion 210, such that the accessibility tab 220 may be rotated relative to the grip portion 210. The accessibility tab 220 has a cam surface 222 at one end 224, and a lever 226 at the opposite end 228. The lever 226 may be flipped up, as shown in FIG. 23, causing the cam surface 222 to press against the part of the back shell 200 underneath the accessibility tab 220. Pressing the cam surface 222 against the back shell 200 causes the grip portion 210 to slide backward relative to the back shell 200, disengaging the latches 218. The accessibility tab 220 may be grasped and used to pull the cable assembly away from the corresponding female connector. The lever 226 may have a ridged grip surface 240 to facilitate grasping of the accessibility tab 220.

The use of the accessibility tab 220 to disengage the latches 218, and then to pull the cable assembly away from a mating connector facilitates placement of the cable assembly in tight locations, and placement of multiple cable assemblies in close proximity. The accessibility tab 220 allows placement of cable assemblies in locations where fingers cannot reach onto and grasp both sides of the grip portion 220.

The grip portion 210 and the accessibility tab 220 may be made of plastic. The back shell 200 may be made of metal, such as steel.

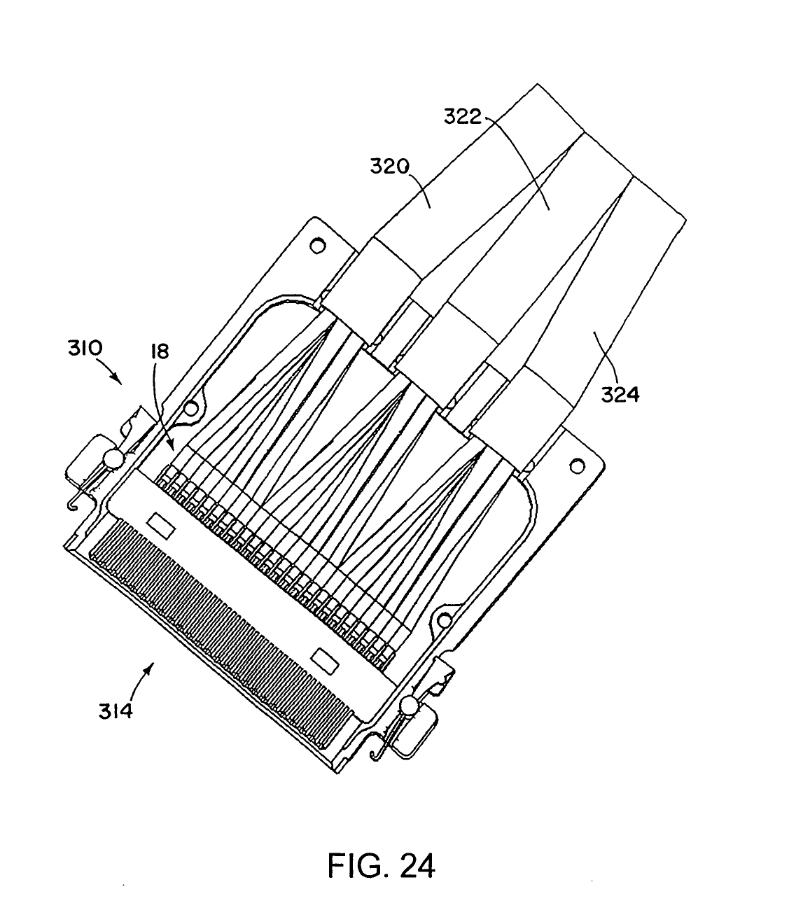

Turning now to FIG. 24, a cable assembly 310 is shown that conforms to a 12X configuration. The cable assembly 310 has a male connector 314 that has 24 pairs of signal contacts. Three cables 320, 322, and 324, each provide eight transmission lines, with each transmission line having two signal wires. By using three separate cables, rather than a single cable containing all of the transmission lines, the cable assembly 310 may be used in tighter spaces. This is because the smaller cables 320, 322, and 324 can be bent at a tighter radius than a single larger cable.

The cable assembly 310 may include multiple modules of the same general configuration as the module 18 (FIG. 1) described above. The cable assembly 310 may be made of similar materials, and may have similar latching mechanisms, as those described above.

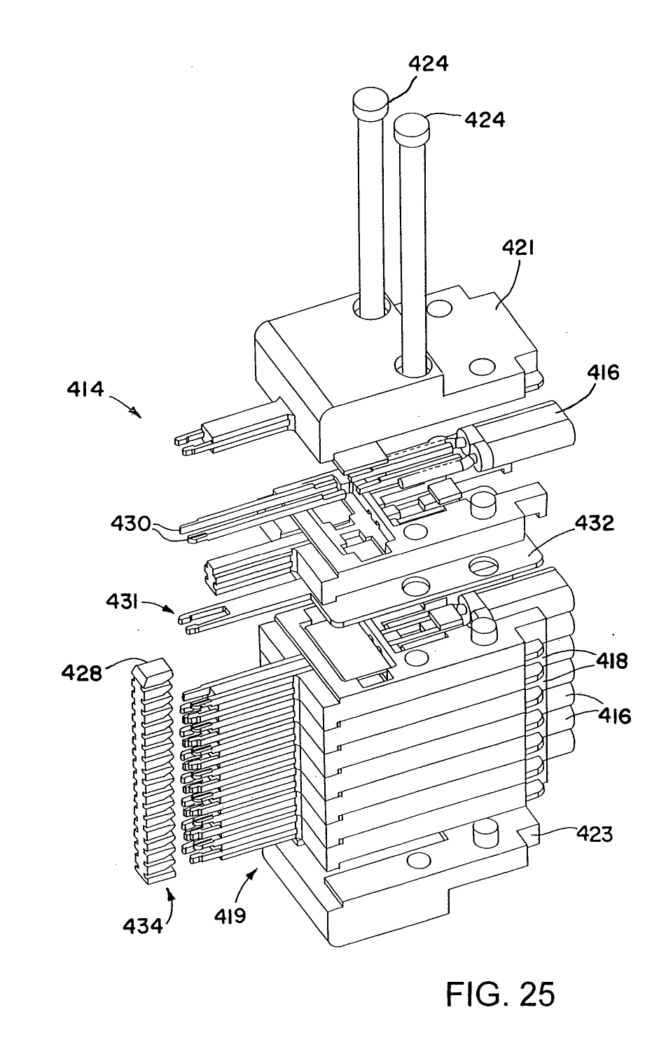

FIG. 25 shows an alternate embodiment male connector 414 for which individual transmission lines 416 of a cable are coupled to respective modules 418 that are stacked together, forming a stack 419. End pieces or modules 421 and 423 are also stacked with the modules 418, and the stack 419 is coupled together by pins 424, which are heat-staked on either side to hold the stack 419 together.

A nosepiece 428 is between signal contacts 430 and shield clip portions 431 of a conductive shield or ground plane 432. The nosepiece 428 snaps into and is secured by the shield clip portions 431. Slots 434 in the nosepiece 428 receive the shield clip portions 431 and ends of the signal contacts 430. The nosepiece 428 functions to maintain a desired spacing of the signal contacts 430 of the various modules 418. The nosepiece 428 may advantageously aid in maintaining a desired spacing of the modules 418. The nosepiece 428, a plastic molded part with the slots 434 located at the desired spacing, alleviates this potential problem.

The male connector 414 may also advantageously include built-in equalization in each of the modules 418. As described further below, the equalization is coupled to the signal contacts 430 and is between shields 432 of adjacent of the modules 418.

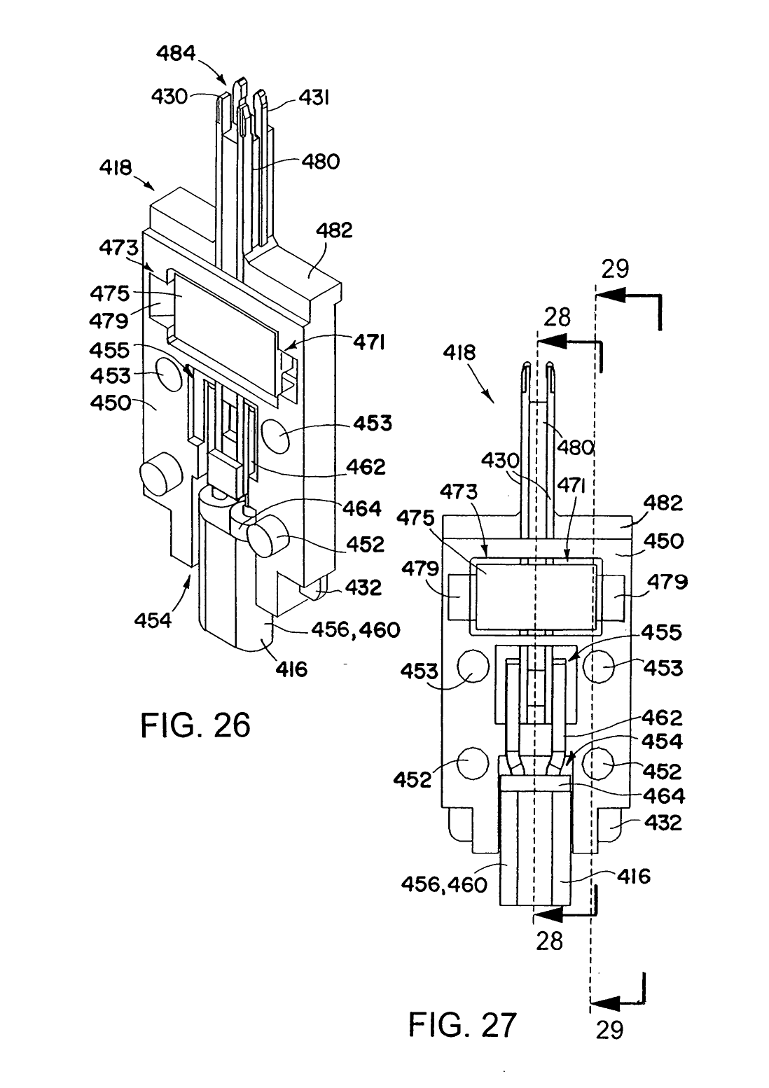

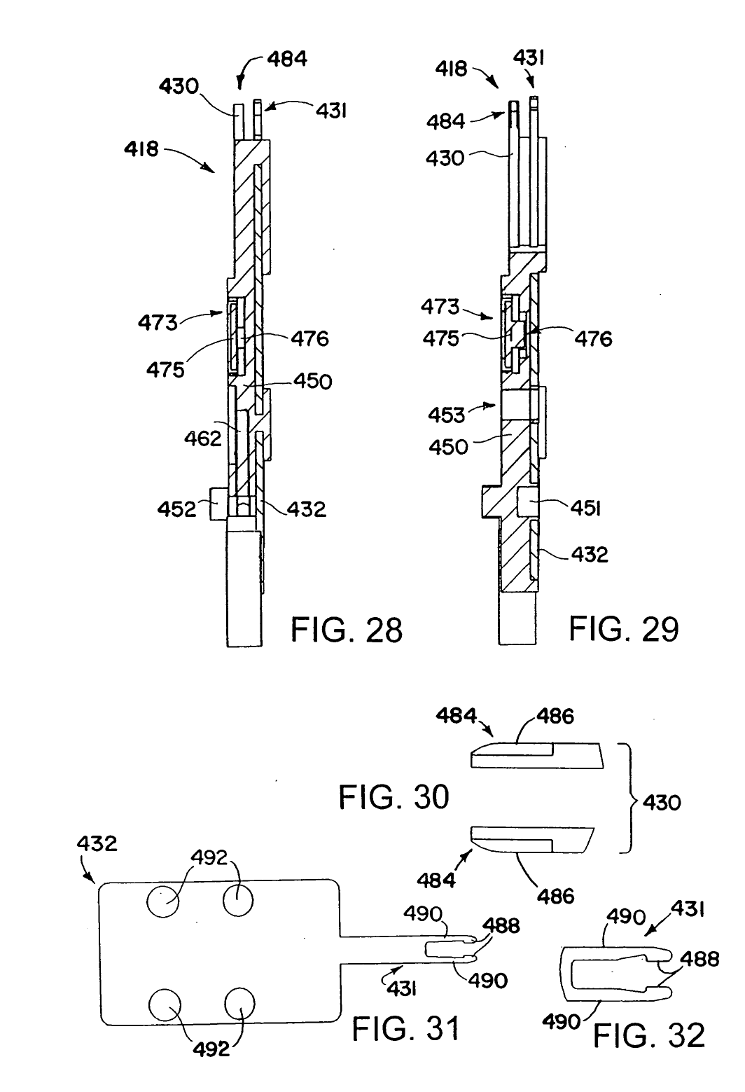

Referring now in addition to FIGS. 26-29, details of the modules 418 are discussed. The modules 418 each include a module body 450, which may be a plastic piece inset molded about the signal contacts 430 to maintain a desired separation and location of the signal contacts 430 and the shield 432. The module body 450 includes recesses 451 for receiving protrusions 452 from an adjacent module 418, allowing the modules 418 to be nested and stacked. The body 450 also includes holes 453 to allow the pins 424 (FIG. 25) to pass therethrough.

The body 450 includes openings 454 and 455 for receiving the transmission line 416. The transmission line 416 includes a protective jacket 456 that covers and encloses a conductive layer of transmission line shielding 460. The shielding 460 provides electrical protection to a pair of signal wires 462, which are enclosed in respective dielectric layers 464. In addition, the shielding 460, which may be aluminum metallized MYLAR shielding, establishes the impedance of the transmission line 416.

The shielding 460 of the transmission line 416 extends into the opening 454, before the individual signal wires 462 of the transmission line 416 are separated from one another, to be joined to the signal contacts 430, within the opening 455. The signal wires 462 may be soldered to or otherwise coupled to the signal contacts 430. The configuration of the signal wires 462 and their coupling to the signal contacts 430 may be similar to that described above with regard to signal wires 62 (FIG. 1).

The shield 432 overlaps both of the openings 454 and 455, as well as overlapping substantially all of the length of the signal contacts 430. The shield 432 also overlaps shielded and unshielded portions of the signal wires 462. Thus shielding is maintained throughout the signal path within the module 418. This maintenance of shielding throughout the module 418 helps maintain impedance matching in the signal path, thus reducing crosstalk in signals, for example reducing crosstalk to about 1% or less.

The module body 450 also includes an opening 471 for receiving an equalization device 473 that is coupled to the signal contacts 430. The equalization device 473 includes a circuit board 475 that has electrical and/or electronic devices mounted thereon or therewithin. The equalization device 473 may be mounted across a gap 476 in the signal contacts 430, wherein each of the signal contacts 430 is separated into two halves.

The equalization device 473 may be any of a variety of devices for controlling quality of signals passing through the signal contacts 430. For instance, the equalization device 473 may be used to allow longer cable lengths by reducing attenuation. The equalization device 473 may be a passive device, such as a passive filter that includes a resistor and a capacitor in parallel. Alternatively, the equalization device 473 may be an active device that includes an integrated circuit that provides active control of the signals.

The equalization device 473 is located between portions of the signal contacts 430, and is directly connected to the signal contacts 430. Also, the equalization device 473 is overlapped by the shield 432, and is thus located between a pair of shields 432 when the modules 418 are stacked together. These characteristics are advantageously contrasted with those of other connectors, which may have equalization devices between signal wires and contacts, and/or outside of shielding. Locating equalization devices between signal wires and contacts, and/or outside of shielding, may cause impedance mismatching, cross talk, or other undesirable electrical characteristics.

The equalization device 473 may be coupled to the signal contacts 430 by first punching out portions of the signal contacts 430 to create the gap 476. The equalization/device 473 may then be inserted into the opening 471, and electrically and mechanically connected to the signal contacts 430 by soldering. Sloped or curved surfaces 479 may flank the opening 471, in order to facilitate cleaning after the soldering process, for example by flushing with water and/or air.

The module body 450 includes a narrow portion 480 extending away from a wider portion 482, toward tips or ends 484 of the signal contacts 430. The narrow portion 480 may have substantially the same width as the distance between the signal contacts 430. When the modules 418 are stacked together, the narrow portions 480 of the module bodies 450, in combination with the nosepiece 428 (FIG. 25), may constitute a interface that supports the ends of the signal contacts 430 during insertion into a corresponding female connector. As shown in FIG. 30, the tips 484 of the signal contacts have ramped surfaces 486, to facilitate insertion of the tips into the nosepiece 428 (FIG. 25), and/or insertion of the male connector 414 into a corresponding female connector.

With reference now in addition to FIGS. 31 and 32, the shield clip portion 431 of the shield 432 has protrusions or bumps 488 thereupon to engage and secure the nosepiece 428 (FIG. 25). The protrusions 488 are on the ends of resilient arms 490 of the shield clip portion 431. In addition, the shield 432 has openings 492 therein to allow passage of the pins 424 (FIG. 25) and the module protrusions 452 (FIG. 26) therethrough.

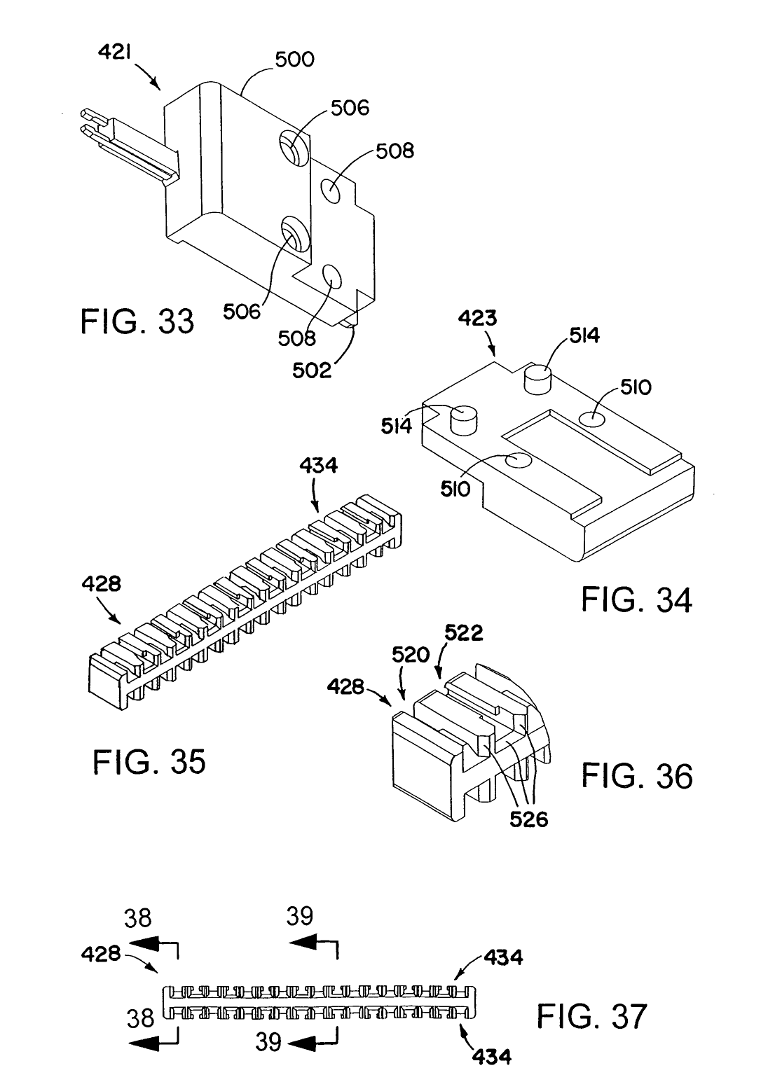

Turning now to FIG. 33, the end module 421 has a plastic module body 500 that is secured to a conductive shield 502, which may be identical to the conductive shield 432 of the modules 418. The module body 500 is configured to mate with the module bodies 450 of the modules 418 to form the stack 419 shown in FIG. 25. To that end, the module body 500 (and the shield 502) have holes 506 for passing the pins 424 (FIG. 25) therethrough. Also, the module body 500 has holes 508 configured to receive protrusions 452 on the module body 450 of the module 418 (FIGS. 26-29).

FIG. 34 shows details of the end module 423, which goes on the opposite side of the stack 425 (FIG. 25) from the end module 421 (FIG. 33). The end module 423 includes holes 510 for letting the pins 424 (FIG. 25) pass therethrough, and includes protrusions 514 configured to mate with corresponding recesses 451 in the modules 418 (FIGS. 26-29). The end module 423 may be made of molded plastic. With reference to FIG. 25, it will be appreciated that the end module 423 does not require a shield, since it mates with one of the modules 418 on a face that is already shielded.

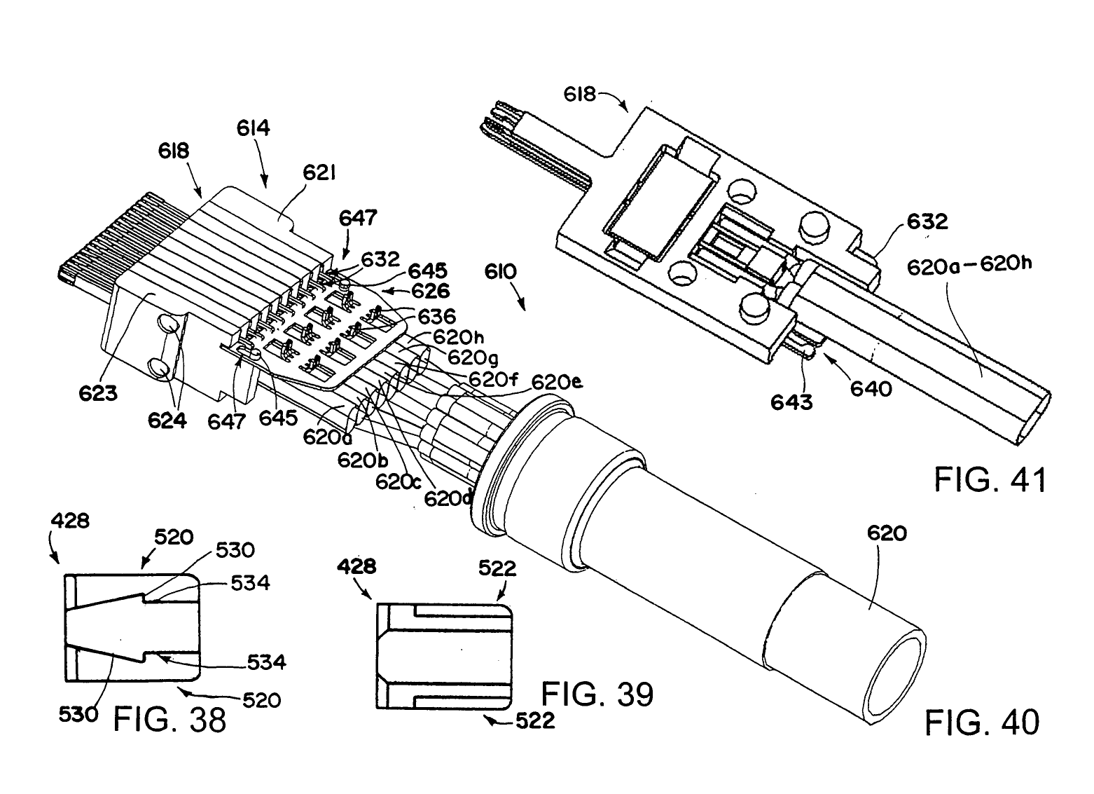

Referring now to FIGS. 35-39, details of the nosepiece 428 are discussed. The slots 434 of the nosepiece 428 include alternating shield clip slots 520 for receiving the shield clip portions 431 (FIG. 25), and signal contact slots 522 for receiving the ends 484 of the signal contacts 430 (FIG. 25). The slots 520 and 522 are on both the top and bottom of the nosepiece 428.

Ramped areas 526 around the slots 520 and 522 are used to urge the shield clip portions 431 into the shield clip slots 520, and to urge the ends 484 of the signal contacts 430 into the signal contact slots 520. The ramped areas 526 about the signal contact slots 520 include ramped bumps 530, which are used to push apart the protrusions 488 (FIG. 26) and resilient arms 490 (FIG. 26) of the shield clip portions 431. After the nosepiece 428 has been pushed a sufficient amount onto the shield clip portions 431, the protrusions 488 of the shield clip portions 431 reach a sudden reduction of thickness of the nosepiece 428 in the form of ledges 534. The protrusions 488 then snap inward, securing the nosepiece 428 to the shield clip portions 431.

The nosepiece 428 has guides 540 on sides of the signal contact slots 522 that aid in maintaining the signal contacts 430 in place within the signal contact slots 522.

The male connector 414 may be contained within a back shell, in a manner similar to that of the male connector 14 described above. It will be appreciated that the male connector 414 and an enclosing back shell may be part of a cable assembly capable of mating with standard I-O interfaces such as the 4X and 12X interfaces. Accordingly, the number of modules 418 and the number of slots 434 in the nosepiece 428 may be varied as desired.

Turning now to FIG. 40, a cable assembly 610 includes a male connector 614 that is coupled to transmission lines 620a-620h of a cable 620. The male connector 614 has a series of modules 618 stacked and fixed together by pins 624, with end modules 621 and 623 at opposite ends of the stack. Pairs of signal wires of each of the transmission lines 620a-620h are coupled to signal contacts of respective of the modules 618, 621, and 623, in a manner similar to that of the modules 418 of the male connector 414 (FIG. 25).

The male connector 614 has a ground bus 626 which is coupled to conductive shields 632 of the modules 618, 621, and 623. The ground bus 626 may be a substantially planar copper alloy plate, substantially perpendicular to the modules 618, 621, and 623. The ground bus 626 has clips 636 for receiving and securing ground wires of the cable 620. The clips 636 may be forks each with arms that resiliently move apart as a ground wire is pressed in, and resiliently secure the ground wire once it is pressed in. The clips 636 may be similar to well-known insulation displacement contacts. Alternatively, other methods, such as soldering, may be used to secure the ground wires to the ground bus 626.

The ground bus 626 advantageously allows the coupling between the ground wires and the conductive shields 632 to be moved outside of the modules 618, 621, and 623. By use of the ground bus 626, there is no need to make a direct coupling between the ground wires and the conductive shields 632, in the limited space within the modules 618, 621, and 623.

Another advantage in using the ground bus 626 is that a smaller number of ground wires may be utilized. More specifically, there may be fewer ground wires in the cable 620 than there are transmission lines 620a-620h (each with a pair of signal wires). Put another way, there may be fewer ground wires than there are modules 618, 621, and 623, because each of the conductive shields 632 does not require a separate connection from one of the ground wires of the cable 620.

FIG. 41 shows details of one of the modules 618. Many of the details of the module 618 are similar to those of the module 418 (FIG. 25), which is discussed in detail above. However, one difference is that the conductive shield 632 has a forked contact 640 for receiving and making electrical contact with the ground bus 626 (FIG. 40). As the ground bus 626 is pushed into the forked contacts 640 of the conductive shields 632, upper arms 643 of the forked contacts 640 are displaced upwards. The upper arms 643 press down against the ground bus 626, making electrical contact between the conductive shields 632 and the ground bus 626, and aiding in mechanically securing the ground bus 626 in place. In addition, with reference to FIG. 40, the end modules 621 and 623 have bosses 645 that engage slots 647 in the ground bus 626. The engagement of the bosses 645 in the slots 647 also aids in maintaining the ground bus 626 in place within the male connector 614.

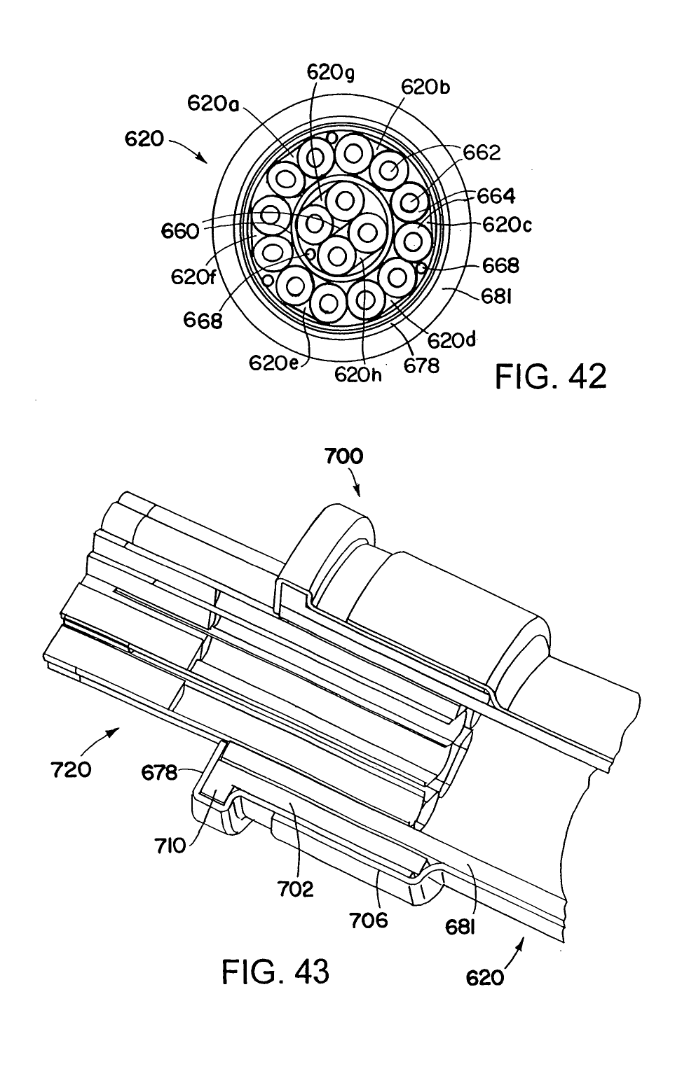

FIG. 42 shows one possible configuration of wires within the cable 620. The transmission lines 620a-620h are each surrounded by respective layers of transmission line shielding 660. The transmission line shielding 660 may be metallized MYLAR with the metal layer facing outward, away from signal wires 662 and dielectric layers 664 around the signal wires 662. Ground wires 668 make contact with the outer conductive layers of the transmission line shielding 660 of multiple of the transmission lines 620a-620h. The ground wires 668 may be wound around various of the transmission lines 620a-620h, such that each of the ground wires 668 is in contact with the transmission line shielding 660 of multiple of the transmission lines 620a-620h, with the outer conductive layers of all of the transmission line shielding 660 being electrically coupled to ground. For example, each of the ground wires 668 may be in contact with the transmission line shielding 660 of two of the transmission lines 620a-620h. The result is that there are only half as many ground wires 668 as there are transmission lines 620a-620h, as in the embodiment shown in FIG. 42, with eight transmission lines and only four ground wires.

The transmission lines 620a-620h and the ground wires 668 are surrounded by a metal braid 678 and a dielectric material casing 681. The metal braid 678 is coupled to an electrical ground, and is electrically coupled to the ground wires 668 and the outer conductive layers of the transmission line shielding 660 of each of the transmission lines 620a-620h. The metal braid 678 may provide some degree of electrical shielding for the cable 620. The dielectric material casing 681 on the outside of the cable 620 may be made of a suitable dielectric material, such as plastic or rubber.

Referring now in addition to FIG. 43, a strain relief 700 at the end of the cable 620 includes a collar 702 and shrink tube 706. The collar 702, which may be made of a suitable molded plastic, includes a ridge 710. In coupling the cable 620 to the male connector 614, the collar 702 is placed around a cut end 720 of the cable 620, before or after removing the casing 681 from the cut end 720. The metal braid 678 at the cut end 720 is then exposed and folded back over the ridge 710 of the collar 702. The shrink tube 706 is then placed around the collar 702 and the cable 620, farther from the cut end 720 of the cable 620 than the ridge 710. The portion of the metal braid 678 over the ridge 710 thus remains outside the shrink tube 706. The shrink tube is then shrunk onto the cable 620, sealing excess of the metal braid that extends much beyond the ridge 710.

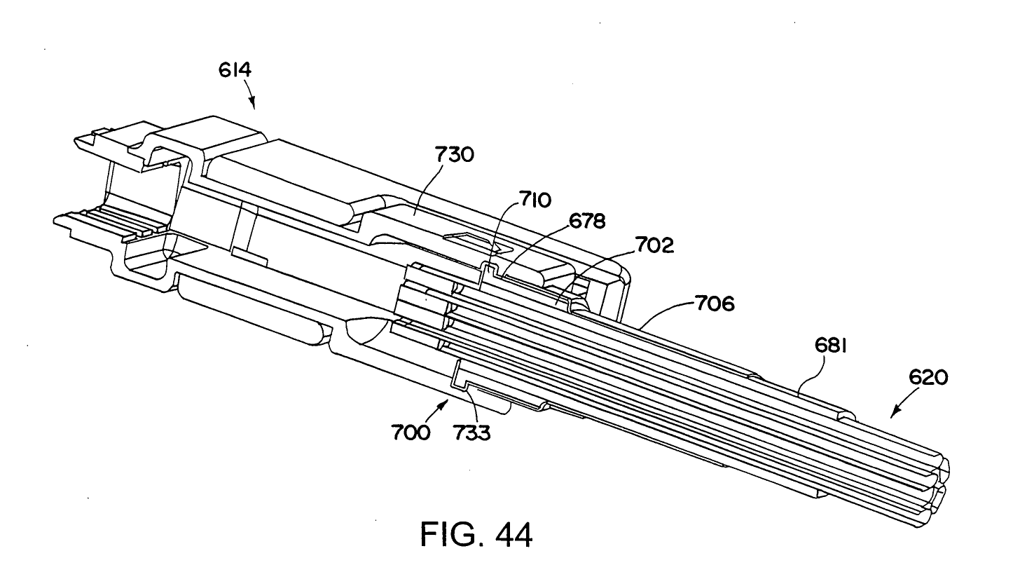

As shown in FIG. 44, the strain relief 700 may be placed in a back shell 730 that is part of the male connector 614, and that houses the stacked modules 618, 621, and 623, as well as the ground bus 626 (FIG. 40). The coupling together of the transmission lines 620a-620h to the modules 618, 621, and 623, and of the ground wires 668 to the ground bus 626, occurs prior to the placement of the strain relief 700 in the back shell 730. The ridge 710 fits into a groove 733 in the back shell 730. When halves of the back shell 730 are joined together, the back shell 730 presses against the portion of the metal braid 678 folded over the ridge 710. The metal body of the back shell 730 is thus brought into electrical contact with the metal braid 678, grounding the back shell 730. The shrink tube 706 covers any folded-over metal braid that would otherwise extend outside of the back shell 730.

The strain relief 700 advantageously requires only a pair of simple, inexpensive parts. The strain relief 700 is easy to install. Perhaps most advantageously, the strain relief moves the need for precision in trimming the metal braid 678 to avoid having exposed metal braid sticking out from back shell 730, since the shrink tube 706 is able to cover a significant excess length of folded-over metal braid. Having exposed metal braid extending beyond the back shell 730 is undesirable because contact between exposed metal braid and other wiring or metal may result in a short circuit or other electrical problem.

Several example embodiment cable assemblies are described herein. It will be appreciated that features described herein with regard to the example embodiments, may be employed in a wide variety of cable assemblies having other characteristics, such as different shapes and/or different configurations of or number of signal contacts.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A cable assembly comprising:
a male connector that includes:
multiple modules stacked together and staked together, wherein each of the modules includes a pair of signal contacts substantially parallel to a planar shield of the module; and
a nosepiece that is coupled to the modules, wherein the nosepiece includes slots for receiving portions of the signal contacts and the shields of each of the modules, to maintain a desired separation between the signal contacts and the shields; and
a cable having signal wires that are coupled to the signal contacts of the modules.

2. The cable assembly of claim 1,
wherein each of the modules includes a conductive shield; and
wherein the nosepiece includes slots for receiving ends of the conductive shields.

3. The cable assembly of claim 2, further comprising a ground bus electrically and mechanically coupled to the conductive shields.

4. The cable assembly of claim 3, wherein the ground bus includes clips for receiving ground wires of the cable.

5. The cable assembly of claim 1, wherein the nosepiece is between the portions of the signal contacts of each of the modules.

6. A male electrical connector comprising:
multiple modules stacked together;
wherein the modules are heat staked together; and
wherein the connector is configured to mate with a 4X/12X connector.

7. An electrical connector comprising:
a pair of signal contacts between planar shields; and
an equalization device directly coupled to the signal contacts;
wherein the equalization device is between the shields and is overlapped by the shields.

8. The connector of claim 7, wherein the equalization device is an active device.

9. The connector of claim 7, wherein the equalization device is a passive device.

10. The connector of claim 7, wherein the equalization device is coupled across gaps in the signal contacts.

11. The connector of claim 10, wherein the gaps are punched-out portions of the signal contacts.

12. The connector of claim 7, wherein the signal contacts are substantially parallel to one another.

13. A cable assembly comprising:
a cable that includes a transmission line having signal wires; and
a connector having signal contacts that are electrically connected to the signal wires;
wherein impedance of the signal wires in a transition line region within the cable is substantially the same as impedance of the signal contacts in a contact region within the connector, and is substantially the same as impedance of the signal wires in a transition region within the connector.

14. The cable assembly of claim 13, wherein the signal contacts of the connector are between substantially planar conductive shields.

15. The cable assembly of claim 14, wherein the signal wires in the transition region are between the conductive shields.

16. The cable assembly of claim 15,
wherein the connector includes multiple modules stacked together; and
wherein the modules each include a pair of signal contacts and a conductive shield.

17. An electrical connector comprising:
signal contacts;
an angled back shell at least partially enclosing the signal contacts, wherein the angled back shell has an opening at one end angled relative to a direction at which the signal contacts are directed at an opposite end; and
a latching mechanism that includes:
latches for coupling the connector to a mating connector;
a grip portion mechanically coupled to the latches, and translatable relative to the angled back shell, wherein the grip portion may be translated relative to the angled back shell to release the latches; and
an accessibility tab mechanically coupled to the grip portion, wherein rotation of the accessibility tab translates the grip portion relative to the angled back shell.

18. The connector of claim 17, wherein the accessibility tab is rotatably coupled to the grip portion.

19. The connector of claim 18, wherein the accessibility tab has a cam surface at one end configured to press against the angled back shell as the accessibility tab is rotated, thereby causing the grip portion to translate relative to the angled back shell.

20. The connector of claim 19, wherein the accessibility tab includes a lever opposite the cam surface.

21. The connector of claim 20, wherein the lever includes a ridged grip surface.

22. The connector of claim 17, wherein the grip portion includes sloped surfaces that press against an rotate rocker arms that are coupled to the latches, when the grip portion is translated relative to the back shell.

23. The connector of claim 17, as part of a cable assembly that includes a cable that has signal wires that passes through the opening in the back shell and engage the signal contacts.

24. An electrical connector comprising:
a plurality of modules stacked together, wherein each of the modules includes a conductive shield, and wherein the conductive shields are located between pairs of adjacent modules; and
a ground bus mechanically and electrically coupled to each of the conductive shields.

25. The connector of claim 24, wherein the ground bus includes a substantially planar conductive plate.

26. The connector of claim 25, wherein the planar conductive plate of the ground bus is substantially perpendicular to the modules.

27. The connector of claim 24, wherein ground bus is resiliently gripped by each of the conductive shields.

28. The connector of claim 27, wherein each of the conductive shields has a forked contact for receiving and resiliently gripping the ground bus.

29. The connector of claim 27, wherein edge modules of the multiple modules have bosses that engage slots of the ground bus.

30. The connector of claim 24, wherein the ground bus includes clips for receiving and securing ground wires.

31. A cable assembly comprising:
a cable having a dielectric casing and a metal braid within the dielectric casing;
a collar over an end of the cable, wherein the collar includes an external ridge extending radially outward; and
a shrink tube;
wherein the metal braid is folded outward over the ridge of the collar; and
wherein the shrink tube is placed over and seals free ends of the metal braid.

32. The cable assembly of claim 31, wherein the shrink tube overlies a portion of the collar.

33. The cable assembly of claim 32, wherein the shrink tube also overlies a portion of the cable not covered by the collar.

34. The cable assembly of claim 32, wherein the collar is a plastic collar.

35. The cable assembly of claim 32,
further comprising a connector that includes a back shell,
wherein back shell has a groove therein for receiving external ridge of the collar and the overlying metal braid.

36. The cable assembly of claim 35, wherein the back shell includes a pair of mating halves that press on the metal braid that overlies the external ridge of the collar, thereby electrically coupling the metal braid and the back shell.
